(19) United States
(12) Patent Application Publication
(10) Pub. No.: US 2020/0093575 A1
(43) Pub. Date: Mar. 26, 2020

(54) MOUTHPIECE FOR APPLICATION OF VIBRATION TO DENTITION

(71) Applicant: Advanced Orthodontics and Education Association, LLC, Ossining, NY (US)

(72) Inventors: Bryce A. WAY, San Jose, CA (US); Richard JOHNSON, Briarcliff Manor, NY (US)

(73) Assignee: Advanced Orthodontics and Education Association, LLC, Ossining, NY (US)

(21) Appl. No.: 16/142,461

(22) Filed: Sep. 26, 2018

(51) Int. Cl. A61C 7/00

(52) U.S. Cl. CPC A61C 7/008

(57) ABSTRACT

A device and method for delivering vibration to a dentition of the user is provided. The device includes a mouthpiece body configured to be placed intraorally and a plurality of pads coupled to a perimeter of the mouthpiece body. The mouthpiece body comprises a convex curvature that approximately corresponds to a curvature of the user's palate. The mouthpiece body further comprises at least one open portion configured to permit passage of any liquid that accumulates around the mouthpiece body during use. During use, the plurality of pads is configured to be placed in vibrational contact with the dentition of the user.

### BACKGROUND

### Technical Field

The present disclosure generally relates to dental and orthodontic devices and methods. More particularly, and without limitation, the disclosed embodiments relate to devices and methods for delivering high frequency acceleration (HFA) or high frequency vibration (HFV) to a user's dentition.

### Background Description

Orthodontic treatment continues to grow in popularity among both teens and adults. While social stigmas associated with orthodontic treatment are in decline, many are still hesitant to consider treatment. The length of treatment time, and fear of pain associated with treatment are the most prevalent concerns cited as the barriers to treatment acceptance. Studies have demonstrated that 58.3% of the subjects cited orthodontic pain as their primary complaint, followed closely by treatment duration. One factor that contributes to the pain and discomfort felt by the patients is poor aligner seating. When the aligners are not adequately seated, the aligner tray can lose its grip around the patient's teeth, which results in improper distribution of forces on the teeth. Therefore, the patient's teeth can move in an unexpected or non-advantageous manner, thereby producing pain and discomfort for the patients. As competition for new patients continues to increase, successful orthodontic practices continue to seek ways to differentiate their services, while addressing these cited concerns of potential and existing patients.

Vibration in conjunction with orthodontic forces has been studied in various frequencies and force levels with mixed results (Woodhouse 2015 and Ottoson 1981). It appears that frequency and force appear to correlate with the therapeutic responses associated with vibration therapy (Lala 2016). Previous literature and studies have demonstrated that vibration at low frequency was not effective at reducing pain originating from teeth (Woodhouse 2015 and Lala 2016), where vibration at high frequency was (Ottoson 1981 and Lala 2016). A possible mechanism is the “gate control” theory, which suggests that pain can be reduced by simultaneous activation of nerve fibers that conduct non-noxious stimuli. Another possibility is that vibration may help relieve compression of the periodontal ligament (PDL), thus promoting normalized circulation (Long 2016). In addition, high frequency vibration may improve seating of the aligners, thereby eliminating unplanned and unwanted teeth movement, allowing better tracking of teeth movement, and ultimately reducing pain and discomfort.

Use of nonsteroidal anti-inflammatory drugs (NSAIDs) to manage pain conjunction with orthodontic tooth movement has been shown to decrease prostaglandin synthesis leading to a decrease in the inflammatory bone resorption process and may negatively impact tooth movement. Therefore, efforts to find ways to increase compliance and manage pain as it relates to patient treatment satisfaction, as well as ways to provide more efficient treatment continue, along with efforts to address perceived pain for patients reluctant to accept treatment.

In addition to reducing pain and discomfort, mechanical vibration may enhance musculoskeletal properties. For example, some studies suggest that low-intensity mechanical vibrations may stimulate bone formation or mitigate the degradation of the intervertebral disc in rats. However, the biomolecular mechanisms for such enhancement effects have not yet been elucidated. Some studies suggested that mechanical vibration may enhance differentiation of human bone marrow mesenchymal stem cells or periodontal ligament stem cells. But discrepancies and unpredictability exist in literature as to the effects of mechanical vibration on cell proliferation. For example, previous studies have demonstrated no effects or either increased or decreased proliferation after cyclic vibration treatment (Zhang 2012).

It is recently hypothesized that mechanical vibration may promote periodontal regeneration and periodontal tissue remodeling during and following orthodontic tooth movement. However, variables of mechanical vibration to be used for modulating bone biology so as to effectively accelerate orthodontic tooth movement remain to be determined.

It would be advantageous to have a device and method for delivering vibration to the user's dentition in order to manage pain, enhance musculoskeletal properties, accelerate tooth movement, and improve seating of aligners. For example, when used in conjunction with orthodontic treatments, such as bracket-and-wire braces or aligners, the device could successfully reduce orthodontic pain or discomfort as well as the duration of treatment by delivering high frequency vibration to the dentition of the user.

### SUMMARY

The embodiments of the present disclosure include devices and methods for delivering vibration to the dentition of the user. Advantageously, the exemplary embodiments provide a device and method for delivering vibration to the dentition of a user with an open bite. For example, according to the exemplary embodiments, the device may be adjusted to provide optimal contact with the dentition of a user with incisor malocclusion, frequently accompanying an open bite.

According to an exemplary embodiment of the present disclosure, a device for delivering vibration to a dentition of a user is provided. The device can include a mouthpiece body. The mouthpiece body can be configured to be placed intraorally. The device can further include a plurality of pads. For example, the device can include about 2 pads, 3 pads, 4 pads, 5 pads, 6 pads, 7 pads, or 8 pads. It is contemplated that in other embodiments, the device can include approximately 10 pads. The pads can be coupled to the perimeter of the mouthpiece body. In other aspects, the pads can be bilaterally asymmetric. The pads can be placed equidistant from each other. The mouthpiece body can include a convex curvature that approximately corresponds to a curvature of the user's palate. In some embodiments, the mouthpiece body can further include at least one open portion. For example, the mouthpiece body can include between approximately 1 and approximately 10 open portions. In an exemplary embodiment, the mouthpiece body can include two open portions. The pads, also, can be placed in vibrational contact with the dentition of the user. In addition, one or more pads can be placed in vibrational contact with the dentition of the user based on the user's tooth type, e.g., molar(s), incisor(s), cuspid(s), canine(s), etc.

The device can further be, in some aspects, waterproof. For example, the mouthpiece body can be waterproof and/or the pads can be waterproof. In some embodiments, only a portion of the mouthpiece body, the pads, or both can be waterproof. The mouthpiece body can, also, be made of a smooth and rigid material. The smooth and rigid material can, in some aspects, be porcelain, plastic, polypropylene, polyurethane, polycarbonate, or a combination thereof. The plurality of pads can, in some aspects, be made of resilient material. The resilient material can, for example, comprise silicone.

The plurality of pads of the device can, in some aspects, contact different surfaces of the dentition of the user. For instance, the pads can be in vibrational contact with the occlusal, labial, or lingual surfaces of the dentition of the user.

The open portion(s) of the device can, in some aspects, permit passage of any liquid that accumulates around the mouthpiece body during use. For example, the open portion(s) of the device can allow passage or drainage of any saliva that accumulates around the user's dentition, oral cavity, the mouthpiece body, the plurality of pads, or any combination thereof.

The device can further include, in some aspects, a plurality of pads that are thicker than the mouthpiece body. For example, a ratio of a thickness of the pads to a thickness of the mouthpiece body can be between about 2:1 and about 6:1.

The device can further include, in some aspects, a vibration unit. The vibration unit can be configured to deliver vibration to the dentition of the user. The vibration unit can be removably coupled to the plurality of pads, the mouthpiece body, or both. The vibration unit, in some aspects, can include a power source and a motor for adjusting a frequency or g-force of vibration. The vibration unit can deliver vibration at a frequency between about 30 Hz and about 200 Hz. The vibration frequency can be, for example, from about 80 Hz to about 120 Hz, from about 110 Hz to about 120 Hz, from about 100 Hz to about 110 Hz, from about 90 Hz to about 100 Hz, or from about 80 Hz to about 90 Hz. It is contemplated that in other embodiments, the frequency could be any value within the range of about 30 Hz to about 200 Hz, and that the vibration frequency could be adjusted during a treatment period. In one exemplary embodiment, the vibration frequency is about 100 Hz. In other aspects, the vibration unit can deliver vibration at a g-force between about 0.01 G and about 0.5 G. In some embodiments, the vibration unit can deliver vibration, for example, at a g-force between about 0.03 G and about 0.2 G. The g-force of the vibration can be adjusted.

According to another embodiment of the present disclosure, the plurality of pads may be removably coupled to the mouthpiece body. The plurality of pads may comprise a first set of proximal pads and a second set of distal pads. The proximal pads may be located proximal to the vibration unit removably coupled to the mouthpiece body. The distal pads may be located distal to the vibration unit removably coupled to the mouthpiece body. The first set of proximal pads may have a thickness that is greater than a thickness of the second set of distal pads. For example, the thickness of the first set of proximal pads may be in a range from about 6 mm to about 12 mm, while the thickness of the second set of distal pads may be about 4 mm. The first set of proximal pads may be thicker than the second set of distal pads such that the proximal pads may provide contact with incisor malocclusion accompanying an open bite. As such, the thickness of the plurality of pads may be adjusted based on the condition of the user's dentition such that the device can provide optimal vibrational contact between the pads and the dentition of the user.

According to another exemplary embodiment of the present disclosure, a method of delivering vibration to a dentition of the user is provided. The method can include placing a mouthpiece body intraorally. The mouthpiece body can include a plurality of pads. For example, the mouthpiece body can include about 2 pads, 3 pads, 4 pads, 5 pads, 6 pads, 7 pads, or 8 pads. It is contemplated that in other embodiments, the mouthpiece body can include approximately 10 pads. The pads can be coupled to the perimeter of the mouthpiece body. The pads can be placed equidistant from each other. The mouthpiece body can include a convex curvature that approximately corresponds to a curvature of the user's palate. In some embodiments, the mouthpiece body can further include at least one open portion. For example, the mouthpiece body can include between approximately 1 and approximately 10 open portions. In an exemplary embodiment, the mouthpiece body can include two open portions. The pads, also, can be placed in vibrational contact with the dentition of the user.

The method can further include, in some aspects, placing a plurality of pads in vibrational contact with different surfaces of the dentition of the user. For instance, the plurality of pads can be placed in vibrational contact with the occlusal, labial, or lingual surfaces of the dentition of the user. In some embodiments, the plurality of pads may be removably coupled to the mouthpiece body. The plurality of pads may comprise a first set of proximal pads and a second set of distal pads. The proximal pads may be located proximal to the vibration unit removably coupled to the mouthpiece body. The distal pads may be located distal to the vibration unit removably coupled to the mouthpiece body. The first set of proximal pads may have a thickness that is greater than a thickness of the second set of distal pads. For example, the thickness of the first set of proximal pads may be in a range from about 6 mm to about 12 mm, while the thickness of the second set of distal pads may be about 4 mm. The first set of proximal pads may be thicker than the second set of distal pads such that the proximal pads may provide contact with incisor malocclusion accompanying an open bite. As such, the thickness of the plurality of pads may be adjusted based on the condition of the user's dentition such that the device can provide optimal vibrational contact between the pads and the dentition of the user.

According to other exemplary embodiments, the open portion(s) of the mouthpiece body can permit passage of any liquid that accumulates around the mouthpiece body during use. For example, the open portion(s) of the mouthpiece body can allow passage or drainage of any saliva that accumulates around the user's dentition, oral cavity, the mouthpiece body, the plurality of pads, or any combination thereof when the mouthpiece body is placed intraorally

The method of delivering vibration to a dentition of the user can, in some aspects, be used when the user is undergoing orthodontic treatment. For instance, the user can be wearing bracket-and-wire braces or at least one aligner. If the user is wearing at least one aligner, the pads can be placed in vibrational contact with the at least one aligner. The method can also, in some aspects, improve seating of the at least one aligner. For instance, the method can further include improving a seating of the at least one aligner by adjusting an amount of vibrational contact between the pads and the dentition of the user. In one exemplary embodiment, the amount of vibration contact between the pads and the dentition of the user can be adjusted by adjusting an amount of upward force that is placed on the mouthpiece body. For example, the user can place an upward force on the mouthpiece body with the user's tongue in order to increase the amount of vibrational contact between the pads and the dentition of the user.

The method can further include, in some aspects, adjusting the frequency or g-force of the vibration that is delivered to the dentition of the user. The vibration unit, in some aspects, can include a power source and a motor for adjusting a frequency or g-force of vibration. The method, in some aspects, can include delivering vibration at a frequency between about 30 Hz and about 200 Hz to the dentition of the user. The vibration frequency can be, for example, from about 80 Hz to about 120 Hz, from about 110 Hz to about 120 Hz, from about 100 Hz to about 110 Hz, from about 90 Hz to about 100 Hz, or from about 80 Hz to about 90 Hz. It is contemplated that in other embodiments, the frequency could be any value within the range of about 30 Hz to about 200 Hz, and that the vibration frequency could be adjusted during a treatment period. In one exemplary embodiment, the vibration frequency is about 100 Hz. In other aspects, the vibration unit can deliver vibration at a g-force between about 0.01 G and about 0.5 G. In some embodiments, the vibration unit can deliver vibration, for example, at a g-force between about 0.03 G and about 0.2 G. The g-force of the vibration can be adjusted.

Additional features and advantages of the disclosed embodiments will be set forth in part in the description that follows, and in part will be obvious from the description, or may be learned by practice of the disclosed embodiments. The features and advantages of the disclosed embodiments will be realized and attained by the elements and combinations particularly pointed out in the appended claims. It is to be understood that both the foregoing general description and the following detailed description are examples and explanatory only and are not restrictive of the disclosed embodiments as claimed.

The accompanying drawings constitute a part of this specification. The drawings illustrate several embodiments of the present disclosure and, together with the description, serve to explain the principles of the disclosed embodiments as set forth in the accompanying claims.

### BRIEF DESCRIPTION OF THE DRAWINGS

FIG. 1 illustrates an exemplary device for delivering vibration to the dentition of the user, in accordance with the embodiments of the present disclosure.

FIG. 2A illustrates an exemplary device for delivering vibration to the dentition of the user, in accordance with another embodiment of the present disclosure.

FIG. 2B illustrates a bottom view of the exemplary device of FIG. 2A, in accordance with an embodiment of the present disclosure.

FIG. 2C illustrates a side view of the exemplary device of FIGS. 2A and 2B, in accordance with an embodiment of the present disclosure.

FIG. 2D illustrates a back view of the exemplary device of FIGS. 2A, 2B, and 2C in accordance with an embodiment of the present disclosure.

FIG. 3 illustrates an exemplary device for delivering vibration to the dentition of the user, in accordance with another embodiment of the present disclosure.

FIG. 4 illustrates an exemplary device for delivering vibration to the dentition of the user, in accordance with another embodiment of the present disclosure.

FIG. 5 is a diagram of a user clamping an exemplary device for delivering vibration to the dentition of the user, in accordance with the embodiments of the present disclosure.

FIG. 6 is a flowchart of an exemplary method for delivering vibration to the dentition of the user, in accordance with the embodiments of the present disclosure.

### DETAILED DESCRIPTION

The disclosed embodiments relate to devices, systems, and methods for delivering vibration to the dentition of the user. Advantageously, embodiments of the present disclosure can be implemented in an orthodontic treatment for accelerating orthodontic tooth movement, reducing pain or discomfort, improving seating of certain orthodontic appliances, enhancing musculoskeletal properties, or any combination thereof. In addition, embodiments of the present disclosure may improve tongue posture, which may contribute to open bite and palate malformation.

Studies have shown that applying vibrational forces to the dentition of the user for approximately 5 to 20 minutes daily significantly reduces the pain and discomfort during the first 3 days of clear aligner treatment. These studies are in agreement with previous studies that have recommended vibrational forces for reduction of pain for dental pain (Ottoson 1981) and tooth pain during orthodontics treatment (Marie 2003). The pain and discomfort can be reduced by providing better aligner seating using vibrational forces. By providing better aligner seating, applying vibrational forces to the dentition of the user can improve distribution of forces on the user's teeth and allow better tracking of teeth movement.

Pain management is a concern in orthodontic treatment. The literature is replete with evidence of the negative impact discomfort has on compliance with the orthodontic treatment regimen (Krishnan 2007). Further, pain associated with orthodontic treatment is often underestimated by clinicians. A study by Krukemeyer reports that practitioners underestimate pain immediately following the last appointment by 43%, and 58.5% of patients agree or strongly agree with the statement, “I have pain for days after an appointment” (Krukemeyer 2009). With the nature of removable orthodontic appliances such as clear aligner therapy, managing it effectively is paramount. As reported by Keim, ‘pain management and even more important, pain prevention, are given short shrift in many orthodontic training programs’ (Keim 2004). Krishnan states that, ‘Many patients as well as parents consider initial lack of information about possible discomfort during treatment to be a major cause of the poor compliance exhibited” (Krishnan 2007). The literature further suggests that the patients' initial attitude towards orthodontics should be understood during the diagnostic phase itself and should be discussed with the patients in all its reality (Krukemeyer 2009). ‘Setting the table’ at consult by preemptively addressing spoken, or unspoken concerns, as they relate to discomfort with options to manage it, may lead to a better patient experience, as well as improved compliance with therapy.

Delivering vibrational forces to the dentition of the user is capable of not only reducing pain and discomfort, but it is also capable of facilitating tooth movement. Osteoblasts and fibroblasts are intimately involved in facilitating tooth movement and are typically targeted by techniques that aim at accelerating tooth movement in orthodontic treatment. Different approaches, both pre-clinically and clinically, have been attempted to achieve quicker results, but there are still many uncertainties and undetermined variables towards most of these techniques. For example, some commercially available dental devices, such as AcceleDent Aura™, developed by OrthoAccel® Technologies, Inc., are offered to accelerate orthodontic treatment. Patients are advised to wear such dental devices that mechanically stimulate teeth and braces in the form of micro-vibrations at low force and at a frequency of 30 Hz for 20 min per day.

To get the maximum desired results of accelerated orthodontic treatment, further studies are still needed to identify the variables of mechanical vibrational stimulation, such as frequency, strength, and duration. It was discovered that treating cells, such as human osteoblasts and fibroblasts, with mechanical vibration for less than about 20 minutes, for example for about 5 minutes, daily at a frequency higher than about 30 Hz increases the number of cells over a period of time. That a marked improvement of cell proliferation over prior-art treatment methods using a shorter treatment interval is surprising and not suggested by the prior art. Various aspects of the present disclosure are developed based on such discovery.

Delivering vibrational forces to the user's teeth can, also, accelerate tooth movement thereby reducing the overall duration of the orthodontic treatment. Such vibrational devices are capable of accelerating the goal of retention, which is reaching stable occlusion, by increasing bone density faster, promoting faster relaxation of the periodontal ligament (PDL) fibers, and decreasing relapse when worn consistently. Delivering vibrational forces to the dentition of the user can further aid in the growth of bone in the mouth by restoring alveolar bone that may be previously lost due to bad oral health.

Reference will now be made in detail to embodiments and aspects of the present disclosure, examples of which are illustrated in the accompanying drawings. Where possible, the same reference numbers will be used throughout the drawings to refer to the same or like parts.

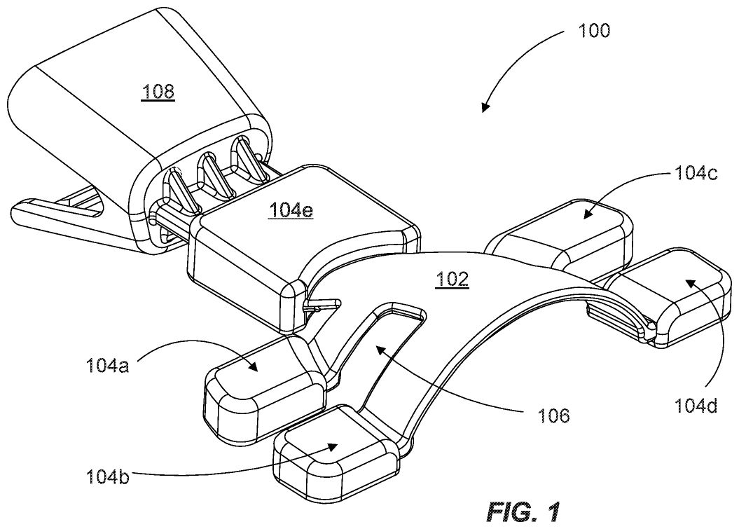

FIG. 1 illustrates an exemplary device 100 for delivering vibration to the dentition of a user. Device 100 includes a mouthpiece body 102, a plurality of pads 104a-e, at least one open portion 106, and a mouthpiece connector 108. Mouthpiece connector 108 can be removably connected to a vibration unit (not shown). The mouthpiece connector 108 or the vibration unit can include a motor (not shown). The mouthpiece body 102 and the plurality of pads 104a-e can be configured to engage some or all of a user's dentition. For example, in the exemplary embodiments shown in FIG. 1, the mouthpiece body 102 and/or the plurality of pads 104a-e are shaped to engage some or all of the user's teeth. As described herein, the shape of the mouthpiece body 102 and the plurality of pads 104a-e is only exemplary. Mouthpiece body 102 and/or the plurality of pads 104a-e may have a customized shape suitable for safe application of vibrational treatment to all or some of a user's teeth. The mouthpiece body 102 can have a convex curvature as depicted in FIG. 1 that approximately corresponds with a curvature of the user's palate. The mouthpiece body 102 and/or the plurality of pads can be made to apply vibration directly to a user's teeth, or to aligners or other appliances applied to the teeth.

The mouthpiece body 102 may have a convex curvature as depicted in FIG. 1 in order to improve the tongue posture of the user. For example, the user's tongue posture may contribute to open bite cases or palate malformation cases. As such, providing a convex structure may provide comfort and ease of use of device 100 because the tongue can rest underneath the convex structure comfortably. Therefore, the convex curvature of the mouthpiece body 102 may help train the user's tongue to contact the convex curvature, and thus, stay on the upper part of the mouth or the palate. By training the tongue to stay on the upper part of the mouth or the palate, the device 100 may help improve the user's open bite. Moreover, the convex curvature of the mouthpiece body 102 may train the user not to push on front teeth with the user's tongue. Therefore, the convex curvature of the mouthpiece body 102 may prevent the user from pushing on the front teeth with the user's tongue and prevent the user from ruining the straightened teeth by pushing on them.

The mouthpiece body 102 may be made of smooth or rigid material, or both. This way, there may be less attenuation of vibration through the mouthpiece body 102 until the vibrations reach the user's teeth via the plurality of pads 104a-e. In addition, the mouthpiece body 102 can be made of material that is capable of being slightly bent in order to slightly adjust the curvature of the mouthpiece body 102 based on the shape of the user's palate. In exemplary embodiments, the mouthpiece body 102 can be made of porcelain, plastic, polypropylene, polyurethane, or polycarbonate. The mouthpiece body 102 can be waterproof so that any liquid that forms around or inside the user's mouth, the mouthpiece body 102, and the plurality of pads 104a-e will not interfere with the functionality of the device 100. In addition, the mouthpiece body 102 may be waterproof in order to provide ease of cleaning before, during, or after use.

On the other hand, the plurality of pads 104a-e can be made with resilient material in order to increase patient comfort, especially when the user clamps on the plurality of pads 104a-e during use. For example, the plurality of pads 104a-e can be made of silicone. In addition, the plurality of pads 104a-e may be made with resilient material in order to provide dampening of the vibrational force and/or the vibratory waveform to modulate the applied force onto the dentition of the user. This way, users, who are sensitive to the vibrational force, may be able to use the device 100 comfortably. Furthermore, if the user is already undergoing orthodontic treatment, such as wearing bracket-and-wire braces, the resilient material of the pads 104a-e may modulate the vibrational force so that the force is less likely to result in bonding failure between the brackets and the tooth surface.

The plurality of pads 104a-e may be removably coupled to mouthpiece body. For example, the user may remove the plurality of pads 104a-e from the mouthpiece body 102 and replace them with new pads. The plurality of pads 104a-e may also be waterproof. Although in FIG. 1, there are only five pads 104a-e coupled to the mouthpiece body 102, in other embodiments, it is contemplated that the mouthpiece body can include about 2 pads, 3 pads, 4 pads, 5 pads, 6 pads, 7 pads, 8 pads, 9 pads, or 10 pads.

In other embodiments, the thickness of the plurality of pads 104a-e may be the same or different. In some aspects, the thickness of the plurality of pads 104a-e may be adjusted to provide optimal contact between the pads and the dentition of the user. For example, the proximal pads 104a, 104c, and 104e may be thicker than the distal pads 104a and 104c to provide optimal contact between the pads and the dentition of a user with an open bite. In FIG. 1, the thickness of the plurality of pads 104a-e is the same. However, as discussed above, the thickness may vary, depending on the shape of the user's mouth or the position of the user's teeth. The thickness may, also, vary depending on the shape and/or position of the orthodontic device the user may be wearing. The ratio of the thickness of the plurality of pads 104a-e to the thickness of the mouthpiece body 102 may range between 2:1 and 6:1. As aforementioned, the thickness of each of the plurality of pads 104a-e may vary. For example, the thickness of pad 104e may be different from that of pads 104a and 104c. In addition, the thickness of pads 104a and 104c may be different from those of pads 104b and 104d. Moreover, the thickness of pad 104c may be different from 104a, and the thickness of pad 104d may be different from that of 104b. In order to adjust the thickness of any of the plurality of pads 104a-e, the user may remove the pads 104a-e from the mouthpiece body 102 and replace with new pads of a desired thickness. This way, the thickness of the pads 104a-e may be adjusted and the device 100 can be customized to the shape of the user's mouth and improve user comfort. Therefore, the device 100 may be adjusted for different bite heights between front back and middle teeth of the user.

As discussed above, the device 100 can be used while the user is undergoing orthodontic treatment. For example, the user can be wearing bracket-and-wire braces, in which case the mouthpiece body 102 may be in direct contact with at least a portion of the user's dentition. In other embodiments, the user can be wearing at least one aligner, in which case the mouthpiece body 102 may be in vibrational contact with at least a portion of the user's dentition through the at least one aligner. In another embodiment, the exemplary device 100 can be used after the user has taken off the braces or aligners and when the user is not wearing any braces or aligners. For example, the exemplary device 100 can be used to reduce oral discomfort after a user has undergone a recent oral surgery, such as receiving an implant.

In some aspects, the mouthpiece body 102 of the device 100 may have at least one open portion 106 to permit passage of any liquid that accumulates around the mouthpiece body 102 during use. For example, the open portion(s) 106 of the device 100 can allow passage or drainage of any saliva that accumulates around the user's dentition, oral cavity, the mouthpiece body 102, the plurality of pads 104a-e, or any combination thereof. In some embodiments, the mouthpiece body 102 can include between approximately 1 and approximately 10 open portions 106. In an exemplary embodiment, the mouthpiece body 102 can include two open portions 106. In other embodiments, the mouthpiece body can include up to 10 open portions 106.

The vibration unit (not shown) or the device 100 can be activated or deactivated when the user depresses a button. The button may be located on the device 100 or on the vibration unit. The user may be able to pause and resume the vibration in the middle of a treatment cycle by depressing the button. The vibration can, also, be deactivated automatically after a predetermined period of time has passed. In a preferred embodiment, the predetermined period of time is less than about 20 minutes, for example about 5 minutes before the vibration deactivates automatically.

The vibration can be activated after the user has placed the mouthpiece body 102 intraorally into vibrational contact with the dentition of a user. In another embodiment, the vibration unit can be activated before the user places the mouthpiece body 102 intraorally into vibrational contact with the dentition of a user.

The mouthpiece connector 108 and the vibration unit (not shown) may be coupled by a joining of the mouthpiece connector 108 and a corresponding connector on the vibration unit (not shown). The exemplary device 100 can be portable and hand-held so that the user can receive vibrational treatment while performing daily tasks. Therefore, the treatment may not interfere with the user's schedule and increase compliance rate.

The device 100 may further include status indicators (not shown). For example, the status indicators can be LED lights. The status indicators can indicate to the user or notify the user the progress of each treatment cycle. For example, the status indicators can notify the user when a 5-minute cycle is in progress, when a user presses a button before treatment is complete, when a 5-minute treatment cycle is interrupted and not completed within a 30-minute time window, when the device is plugged in to a power source, when the battery is low, when the device is fully charged, when the 5-minute treatment cycle is interrupted and the user plugs the device into a USB connection within the 30-minute time window, and when device is on/vibrating and the user plugs the device into a USB connection thereby stopping the vibration. The status indicators can vary in color. For example, the status indicators can produce blue, green, red, magenta, or amber colored lights. In addition, the status indicators can produce a blinking light or a continuous light. In some embodiments, the status indicators can blink at least 3 times in order to indicate a status of the treatment cycle. In other embodiments, the status indicators can blink at least 6 times in order to indicate a status of the treatment cycle.

The device 100 can be removably coupled to a charging cable (not shown). The charging cable could be a USB cable or any other cable that is capable of providing electrical connection between the device 100 and a power source (not shown). The other end of the charging cable can be removably coupled to a power source, which can be a wall adapter or a remote device. In other embodiments, the device 100 can be powered by a battery.

The motor can be installed in the mouthpiece body 102, the plurality of pads 104a-e, the vibration unit (not shown), or any combination thereof. The motor can be connected to electronic circuitries, including a control circuitry and a power circuitry, for operating the motor. Motor may be any type of motor that can cause the mouthpiece body 102 or the plurality of pads 104a-e to vibrate. For example, the motor could be a vibration motor, piezoelectric motor, linear motor, or electromagnetic motor. The frequency and/or g-force of vibration caused by the motor can be adjusted by changing the voltage or current supplied to the motor by the electronic circuitries. For example, the voltage used for operating the motor may range from about 0.5 volts to about 4 volts. The current supplied to the motor may range from about 65 mA to about 100 mA.

The motor may have any suitable mechanical configurations to cause the mouthpiece body 102 or the plurality of pads 104a-e to vibrate axially. The motor may be a counter-weighted motor with a longitudinal axis parallel to the longitudinal axis of the mouthpiece connector 108. The motor may include a counterweight that is off-axis from the longitudinal axis of the motor. When the motor rotates, the counterweight moves up and down, which causes the mouthpiece body 102 to vibrate up and down. Accordingly, when the vibration unit is turned on, the vibration of the mouthpiece body 102 will apply an axial vibratory force on the occlusal, labial, or lingual surfaces of the user's teeth.

In some embodiments, the device 100 may further include one or more sensors (not shown), such as piezoelectric sensors, impedance sensors, optical sensors, or acoustic sensors. The sensors may be configured to detect the frequency or g-force of the vibration of the mouthpiece body 102 or the plurality of pads 104a-e. For example, the sensor may be placed on the outside or the inside edges of the plurality of pads 104a-e, proximate to the user's teeth when the device 100 is clamped between the user's teeth. The sensors can be electrically connected to the electronic circuitries in the vibration unit. Measurements of the sensors can be fed back to the control circuitry of the motor to adjust the g-force and/or frequency of the motor. For example, the detected g-force and/or frequency may be compared to a desired g-force and/or frequency, and the voltage and/or current applied to the motor can be adjusted based on the comparison.

In some embodiments, the motor can be configured to vibrate mouthpiece body 102 and/or the plurality of pads 104a-e at a frequency higher than about 30 Hz, or higher than about 80 Hz, such as at a frequency between about 30 Hz to about 200 Hz. In some aspects, the motor can be configured to vibrate at a frequency between about 100 Hz and about 120 Hz. The motor may be further configured to vibrate mouthpiece body 102 and/or the plurality of pads 104a-e at a g-force ranging between about 0.01 G and about 0.5 G, or between about 0.03 G and about 0.2 G. As described herein, the vibrational frequency of mouthpiece body 102 may vary from the rated “free-air” vibrational frequency of the motor due to the amount of biting force or load applied to mouthpiece body 102, such as the force used to clamp device 100 in place. For example, when the motor is configured to vibrate at a frequency of about 120 Hz, adding biting force or load to mouthpiece body 102 may result in a lower vibrational frequency of mouthpiece body 102 ranging from about 100 Hz to about 120 Hz. The device 100 can be used for less than about 20 minutes, for example for about 5 minutes daily.

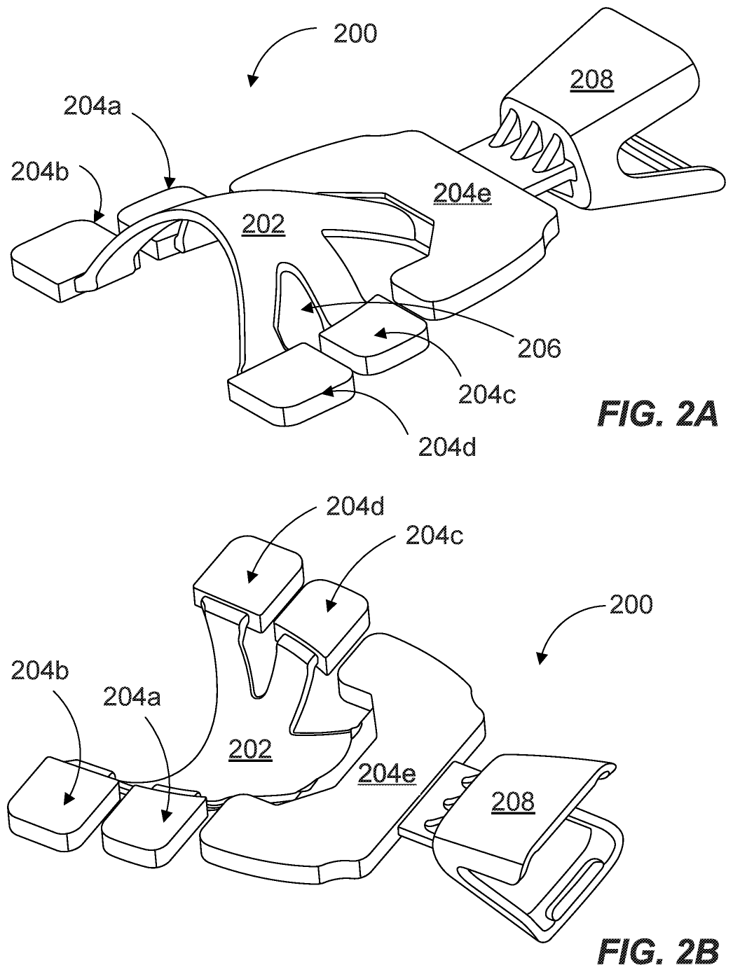

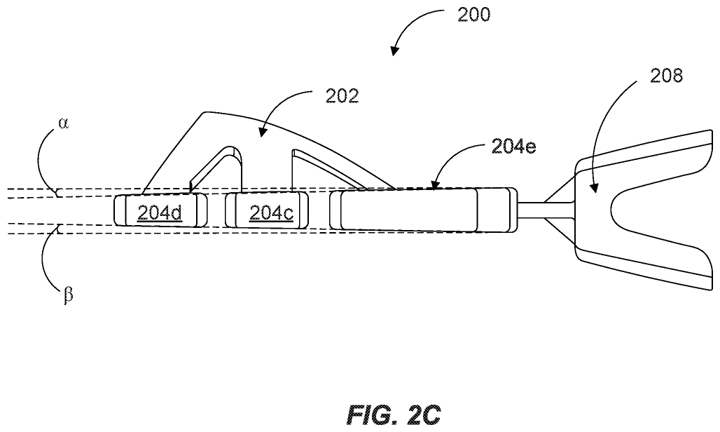

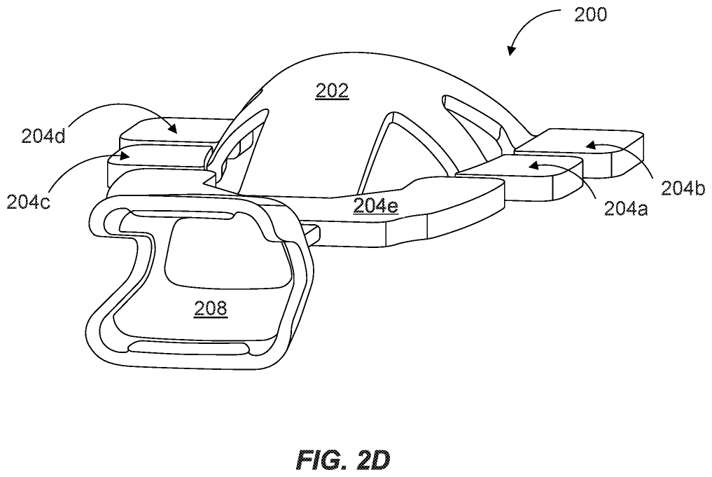

FIGS. 2A-2D illustrate different views of an exemplary device 200 for delivering vibration to the dentition of a user, in accordance with another exemplary embodiment of the present disclosure. The exemplary device 200 may comprise a mouthpiece body 202, a plurality of pads 204a-e, at least one portion 206, and a mouthpiece connector 208. Mouthpiece connector 208 can be removably connected to a vibration unit (not shown). The mouthpiece connector 208 or the vibration unit can include a motor (not shown). The mouthpiece body 202 and the plurality of pads 204a-e can be configured to engage some or all of a user's dentition. For example, in the exemplary embodiments shown in FIGS. 2A-2D, the mouthpiece body 202 and/or the plurality of pads 204a-e are shaped to engage some or all of the user's teeth. For example, the proximal pad 204e may be slightly curved in shape to correspond to the location of the dentition of the user. Thus, the proximal pad 204e may be shaped to provide optimal contact with the dentition of the user. Mouthpiece body 202 and/or the plurality of pads 204a-e may have a customized shape suitable for safe application of vibrational treatment to all or some of a user's teeth. The mouthpiece body 202 can have a convex curvature as depicted in FIGS. 2A-2D that approximately corresponds with a curvature of the user's palate. The mouthpiece body 202 and/or the plurality of pads can be made to apply vibration directly to a user's teeth, or to aligners or other appliances applied to the teeth.

The mouthpiece body 202 may have a convex curvature as depicted in FIGS. 2A-2D in order to improve the tongue posture of the user. For example, the user's tongue posture may contribute to open bite cases or palate malformation cases. As such, providing a convex structure may provide comfort and ease of use of device 200 because the tongue can rest underneath the convex structure comfortably. Therefore, the convex curvature of the mouthpiece body 202 may help train the user's tongue to contact the convex curvature, and thus, stay on the upper part of the mouth or the palate. By training the tongue to stay on the upper part of the mouth or the palate, the device 200 may help improve the user's open bite. Moreover, the convex curvature of the mouthpiece body 202 may train the user not to push on front teeth with the user's tongue. Therefore, the convex curvature of the mouthpiece body 202 may prevent the user from pushing on the front teeth with the user's tongue and prevent the user from ruining the straightened teeth by pushing on them.

The mouthpiece body 202 may be made of smooth or rigid material, or both. This way, there may be less attenuation of vibration through the mouthpiece body 202 until the vibrations reach the user's teeth via the plurality of pads 204a-e. In addition, the mouthpiece body 202 can be made of material that is capable of being slightly bent in order to slightly adjust the curvature of the mouthpiece body 202 based on the shape of the user's palate. In exemplary embodiments, the mouthpiece body 202 can be made of porcelain, plastic, polypropylene, polyurethane, or polycarbonate. The mouthpiece body 202 can be waterproof so that any liquid that forms around or inside the user's mouth, the mouthpiece body 202, and the plurality of pads 204a-e will not interfere with the functionality of the device 200. In addition, the mouthpiece body 202 may be waterproof in order to provide ease of cleaning before, during, or after use.

On the other hand, the plurality of pads 204a-e can be made with resilient material in order to increase patient comfort, especially when the user clamps on the plurality of pads 204a-e during use. For example, the plurality of pads 204a-e can be made of silicone. In addition, the plurality of pads 204a-e may be made with resilient material in order to provide dampening of the vibrational force and/or the vibratory waveform to modulate the applied force onto the dentition of the user. This way, users, who are sensitive to the vibrational force, may be able to use the device 200 comfortably. Furthermore, if the user is already undergoing orthodontic treatment, such as wearing bracket-and-wire braces, the resilient material of the pads 204a-e may modulate the vibrational force so that the force is less likely to result in bonding failure between the brackets and the tooth surface.

The plurality of pads 204a-e may be removably coupled to mouthpiece body. For example, the user may remove the plurality of pads 204a-e from the mouthpiece body 202 and replace them with new pads. The plurality of pads 204a-e may also be waterproof. Although in FIGS. 2A-2D, there are only five pads 204a-e coupled to the mouthpiece body 202, in other embodiments, it is contemplated that the mouthpiece body 202 can include about 2 pads, 3 pads, 4 pads, 5 pads, 6 pads, 7 pads, 8 pads, 9 pads, or 10 pads.

In other embodiments, the thickness of the plurality of pads 204a-e may be the same or different. In some aspects, the thickness of the plurality of pads 204a-e may be adjusted to provide optimal contact between the pads and the dentition of the user. For example, the proximal pads 204a, 204c, and 204e may be thicker than the distal pads 204a and 204c to provide optimal contact between the pads and the dentition of a user with an open bite. As seen in FIG. 2C, the thickness may vary, depending on the shape of the user's mouth or the position of the user's teeth. The thickness may, also, vary depending on the shape and/or position of the orthodontic device the user may be wearing. The ratio of the thickness of the plurality of pads 204a-e to the thickness of the mouthpiece body 202 may range between 2:1 and 6:1. As aforementioned, the thickness of each of the plurality of pads 204a-e may vary. For example, the thickness of pad 204e may be different from that of pads 204a and 204c. In addition, the thickness of pads 204a and 204c may be different from those of pads 204b and 204d. Moreover, the thickness of pad 204c may be different from 204a, and the thickness of pad 204d may be different from that of 204b. In order to adjust the thickness of any of the plurality of pads 204a-e, the user may remove the pads 204a-e from the mouthpiece body 202 and replace with new pads of a desired thickness. This way, the thickness of the pads 204a-e may be adjusted and the device 200 can be customized to the shape of the user's mouth and improve user comfort. Therefore, the device 200 may be adjusted for different bite heights between front back and middle teeth of the user. Moreover, the number of pads 204a-e may be adjusted based on the width of the at least one open portion 206 in the mouthpiece body 202. For example, device 200 may enable selected appliances, such as the pads 204a-e (non-limiting example), like power chains depending on the spaces provided by the at least one open portion 206.

For example, as illustrated in FIG. 2C, proximal pad 204e may be thicker than pad 204c. In addition, pad 204c may be thicker than distal pad 204d. Therefore, a line connecting the top surface of pads 204d, 204c, and 204e may be inclined by angle α. Also, a line connecting the bottom surface of pads 204d, 204c, and 204e may be inclined by angle β. The plurality of pads 204a-e may be adjusted in shape, thereby adjusting angles α and β, in order to provide optimal contact with the dentition of the user. For instance, if the user has an open bite, then proximal pad 204e may need to be thicker than distal pad 204d in order to provide contact between the proximal pad 204e and the front teeth of the user and to provide contact with the incisor malocclusion accompanying an open bite. The proximal pad 204e may range from about 4 mm to 20 mm in thickness. In a preferred embodiment, proximal pad 204e may range from about 6 mm to about 12 mm in thickness. The distal pad 204d may range from about 1 mm to about 5 mm in thickness. In a preferred embodiment, distal pad 204d may be about 4 mm in thickness.

As discussed above, the device 200 can be used while the user is undergoing orthodontic treatment. For example, the user can be wearing bracket-and-wire braces, in which case the mouthpiece body 202 may be in direct contact with at least a portion of the user's dentition. In other embodiments, the user can be wearing at least one aligner, in which case the mouthpiece body 202 may be in vibrational contact with at least a portion of the user's dentition through the at least one aligner. In another embodiment, the exemplary device 200 can be used after the user has taken off the braces or aligners and when the user is not wearing any braces or aligners. For example, the exemplary device 200 can be used to reduce oral discomfort after a user has undergone a recent oral surgery, such as receiving an implant.

In some aspects, the mouthpiece body 202 of the device 200 may have at least one open portion 206 to permit passage of any liquid that accumulates around the mouthpiece body 202 during use. For example, the open portion(s) 206 of the device 200 can allow passage or drainage of any saliva that accumulates around the user's dentition, oral cavity, the mouthpiece body 202, the plurality of pads 204a-e, or any combination thereof. In some embodiments, the mouthpiece body 202 can include between approximately 1 and approximately 10 open portions 206. In an exemplary embodiment, the mouthpiece body 202 can include two open portions 206. In other embodiments, the mouthpiece body can include up to 10 open portions 206.

The vibration unit (not shown) or the device 200 can be activated or deactivated when the user depresses a button. The button may be located on the device 200 or on the vibration unit. For example, in one embodiment, the vibration unit can be connected to the mouthpiece connector 208, and the vibration unit may comprise a button. Once the user depresses the button, the vibration unit may deliver vibrational force to the device 200 so that vibration can be delivered to the dentition of the user. The user may be able to pause and resume the vibration in the middle of a treatment cycle by depressing the button. The vibration can, also, be deactivated automatically after a predetermined period of time has passed. In a preferred embodiment, the predetermined period of time is less than about 20 minutes, for example about 5 minutes before the vibration deactivates automatically.

The vibration can be activated after the user has placed the mouthpiece body 102 intraorally into vibrational contact with the dentition of a user. In another embodiment, the vibration unit can be activated before the user places the mouthpiece body 202 intraorally into vibrational contact with the dentition of a user.

The mouthpiece connector 208 and the vibration unit (not shown) may be coupled by a joining of the mouthpiece connector 208 and a corresponding connector on the vibration unit (not shown). The exemplary device 200 can be portable and hand-held so that the user can receive vibrational treatment while performing daily tasks. Therefore, the treatment may not interfere with the user's schedule and increase compliance rate.

The motor can be installed in the mouthpiece body 202, the plurality of pads 204a-e, the vibration unit (not shown), or any combination thereof. The motor can be connected to electronic circuitries, including a control circuitry and a power circuitry, for operating the motor. Motor may be any type of motor that can cause the mouthpiece body 202 or the plurality of pads 204a-e to vibrate. For example, the motor could be a vibration motor, piezoelectric motor, linear motor, or electromagnetic motor. The frequency and/or g-force of vibration caused by the motor can be adjusted by changing the voltage or current supplied to the motor by the electronic circuitries. For example, the voltage used for operating the motor may range from about 0.5 volts to about 4 volts. The current supplied to the motor may range from about 65 mA to about 100 mA.

The motor may have any suitable mechanical configurations to cause the mouthpiece body 202 or the plurality of pads 204a-e to vibrate axially. The motor may be a counter-weighted motor with a longitudinal axis parallel to the longitudinal axis of the mouthpiece connector 208. The motor may include a counterweight that is off-axis from the longitudinal axis of the motor. When the motor rotates, the counterweight moves up and down, which causes the mouthpiece body 202 to vibrate up and down. Accordingly, when the vibration unit is turned on, the vibration of the mouthpiece body 202 will apply an axial vibratory force on the occlusal, labial, or lingual surfaces of the user's teeth.

The vibration unit (not shown) may further include status indicators (not shown). For example, the status indicators can be LED lights. The status indicators can indicate to the user or notify the user the progress of each treatment cycle. For example, the status indicators can notify the user when a 5-minute cycle is in progress, when a user presses a button before treatment is complete, when a 5-minute treatment cycle is interrupted and not completed within a 30-minute time window, when the vibration unit is plugged in to a power source, when the battery is low, when the vibration unit is fully charged, when the 5-minute treatment cycle is interrupted and the user plugs the vibration unit into a USB connection within the 30-minute time window, and when the vibration unit is on/vibrating and the user plugs the vibration unit into a USB connection thereby stopping the vibration. The status indicators can vary in color. For example, the status indicators can produce blue, green, red, magenta, or amber colored lights. In addition, the status indicators can produce a blinking light or a continuous light. In some embodiments, the status indicators can blink at least 3 times in order to indicate a status of the treatment cycle. In other embodiments, the status indicators can blink at least 6 times in order to indicate a status of the treatment cycle.

The device 200 can be removably coupled to a charging cable (not shown). The charging cable could be a USB cable or any other cable that is capable of providing electrical connection between the device 200 and a power source (not shown). The other end of the charging cable can be removably coupled to a power source, which can be a wall adapter or a remote device. In other embodiments, the device 200 can be powered by a battery.

In some embodiments, the device 200 may further include one or more sensors (not shown), such as piezoelectric sensors, impedance sensors, optical sensors, or acoustic sensors. The sensors may be configured to detect the frequency or g-force of the vibration of the mouthpiece body 202 or the plurality of pads 204a-e. For example, the sensor may be placed on the outside or the inside edges of the plurality of pads 204a-e, proximate to the user's teeth when the device 200 is clamped between the user's teeth. The sensors can be electrically connected to the electronic circuitries in the vibration unit. Measurements of the sensors can be fed back to the control circuitry of the motor to adjust the g-force and/or frequency of the motor. For example, the detected g-force and/or frequency may be compared to a desired g-force and/or frequency, and the voltage and/or current applied to the motor can be adjusted based on the comparison.

In some embodiments, the motor is configured to vibrate mouthpiece body 202 and/or the plurality of pads 204a-e at a frequency higher than about 30 Hz, such as at a frequency between about 80 Hz and 120 Hz, or at a frequency between about 100 Hz to about 120 Hz. The motor may be further configured to vibrate mouthpiece body 202 and/or the plurality of pads 204a-e at a g-force ranging between about 0.01 G and about 0.5 G. In some embodiments, the g-force can range between about 0.03 G and about 0.2 G. As described herein, the vibrational frequency of mouthpiece body 202 may vary from the rated “free-air” vibrational frequency of the motor due to the amount of biting force or load applied to mouthpiece body 202, such as the force used to clamp device 200 in place. For example, when the motor is configured to vibrate at a frequency of about 120 Hz, adding biting force or load to mouthpiece body 202 may result in a lower vibrational frequency of mouthpiece body 202 ranging from about 100 Hz to about 120 Hz. The device 100 can be used for less than about 20 minutes, for example for about 5 minutes daily.

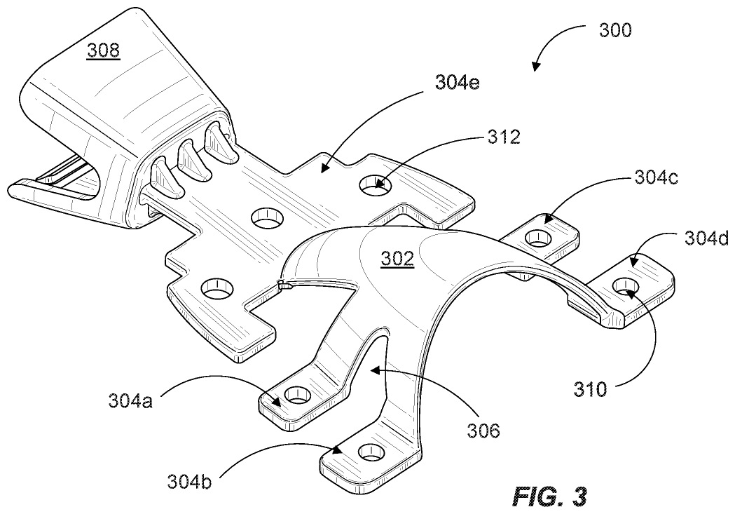

FIG. 3 illustrates an exemplary mouthpiece body 302 of device 300, in accordance with an embodiment of the present disclosure. Device 300 comprises a mouthpiece body 302 and a plurality of contact portions 304a-e. A user may fit a plurality of pads over the plurality of contact portions 304a-e before use. The plurality of contact portions 304a-e may comprise one or more holes 312. The plurality of pads (not shown) may comprise one or more posts (not shown) configured to fit inside the corresponding holes 312 of the contact portions 304a-e. This way, the plurality of pads may be securely attached to the plurality of contact portions 304a-e such that the vibrational force of the device 300 will not move the plurality of pads.

In addition, the mouthpiece body 302 may comprise at least one open portion(s) 306 to permit passage of any liquid that accumulates around the mouthpiece body during use. For example, the open portion(s) 306 of the device 300 can allow passage or drainage of any saliva that accumulates around the user's dentition, oral cavity, the mouthpiece body 302, the plurality of pads (not shown), or any combination thereof.

Device 300 may further comprise a mouthpiece connector 308, which can be removably connected to a vibration unit (not shown). The mouthpiece connector 308 or the vibration unit can include a motor (not shown). The mouthpiece connector 308 and the vibration unit (not shown) may be coupled by a joining of the mouthpiece connector 308 and a corresponding connector on the vibration unit (not shown). The exemplary device 300 can be portable and hand-held so that the user can receive vibrational treatment while performing daily tasks. Therefore, the treatment may not interfere with the user's schedule and increase compliance rate.

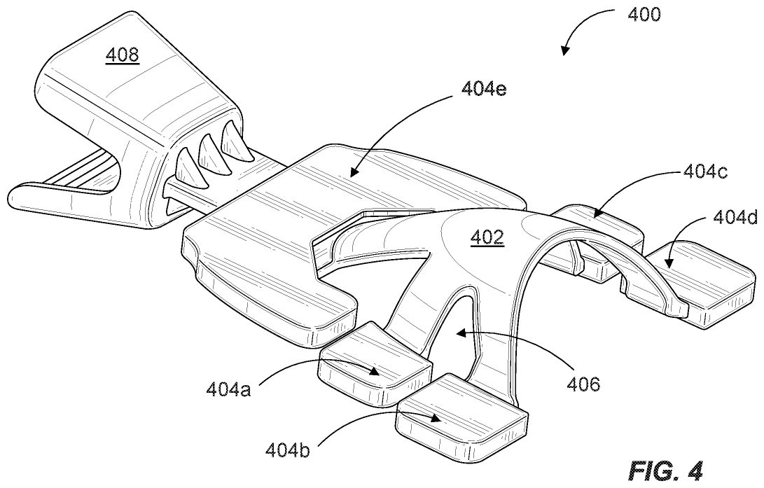

FIG. 4 illustrates an exemplary mouthpiece body 402 (similar to the mouthpiece body 302 in FIG. 3) of device 400. Mouthpiece body 402 may comprise a plurality of pads 404a-e secured to a plurality of contact portions (not shown) similar to the contact portions 304a-e of FIG. 3. The plurality of pads 404a-e can be made with resilient material in order to increase patient comfort, especially when the user clamps on the plurality of pads 404a-e during use. For example, the plurality of pads 404a-e can be made of silicone. In addition, the plurality of pads 404a-e may be made with resilient material in order to provide dampening of the vibrational force and/or the vibratory waveform to modulate the applied force onto the dentition of the user. This way, users, who are sensitive to the vibrational force, may be able to use the device 400 comfortably. Furthermore, if the user is already undergoing orthodontic treatment, such as wearing bracket-and-wire braces, the resilient material of the pads 404a-e may modulate the vibrational force so that the force is less likely to result in bonding failure between the brackets and the tooth surface.

As discussed, the plurality of pads 404a-e may be removably coupled to mouthpiece body 402. For example, the user may remove the plurality of pads 404a-e from the mouthpiece body 402 and replace them with new pads. The plurality of pads 404a-e may also be waterproof. Although in FIG. 4, there are only five pads 404a-e coupled to the mouthpiece body 402, in other embodiments, it is contemplated that the mouthpiece body can include about 2 pads, 3 pads, 4 pads, 5 pads, 6 pads, 7 pads, 8 pads, 9 pads, or 10 pads.

The mouthpiece body 402 may comprise at least one open portion(s) 406 to permit passage of any liquid that accumulates around the mouthpiece body during use. For example, the open portion(s) 406 of the device 400 can allow passage or drainage of any saliva that accumulates around the user's dentition, oral cavity, the mouthpiece body 402, the plurality of pads 404a-e, or any combination thereof.

Device 400 may further comprise a mouthpiece connector 408, which can be removably connected to a vibration unit (not shown). The mouthpiece connector 408 or the vibration unit can include a motor (not shown). The mouthpiece connector 408 and the vibration unit (not shown) may be coupled by a joining of the mouthpiece connector 408 and a corresponding connector on the vibration unit (not shown). The exemplary device 400 can be portable and hand-held so that the user can receive vibrational treatment while performing daily tasks. Therefore, the treatment may not interfere with the user's schedule and increase compliance rate.

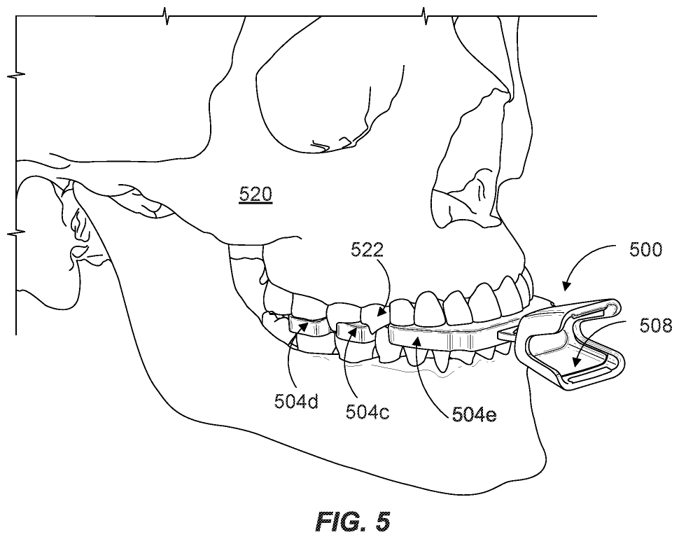

FIG. 5 illustrates a user 520 using an exemplary device 500, in accordance with an embodiment of the present disclosure. The device 500 may comprise a mouthpiece body (not shown), a plurality of pads 504a-e, at least one open portion (not shown), and a mouthpiece connector 508, which may be removably connected to a vibration unit (not shown). Device 500 may be adjusted to provide optimal contact between the dentition 522 of the user 520 and the plurality of pads 504a-e such that device 500 may provide vibrational force to the dentition 522 of the user 520.

The plurality of pads 504a-e can be made with resilient material in order to increase patient comfort, especially when the user clamps on the plurality of pads 504a-e during use. For example, the plurality of pads 504a-e can be made of silicone. In addition, the plurality of pads 504a-e may be made with resilient material in order to provide dampening of the vibrational force and/or the vibratory waveform to modulate the applied force onto the dentition 522 of the user 520. This way, users, who are sensitive to the vibrational force, may be able to use the device 500 comfortably. Furthermore, if the user is already undergoing orthodontic treatment, such as wearing bracket-and-wire braces, the resilient material of the pads 504a-e may modulate the vibrational force so that the force is less likely to result in bonding failure between the brackets and the tooth surface.

As discussed, the plurality of pads 504a-e may be removably coupled to mouthpiece body 502. For example, the user 520 may remove the plurality of pads 504a-e from the mouthpiece body 502 and replace them with new pads. The plurality of pads 504a-e may also be waterproof. Although in FIG. 5, there are only five pads 504a-e coupled to the mouthpiece body 502, in other embodiments, it is contemplated that the mouthpiece body can include about 2 pads, 3 pads, 4 pads, 5 pads, 6 pads, 7 pads, 8 pads, 9 pads, or 10 pads.

The plurality of pads 504a-e may comprise one or more proximal pads 504e and one or more distal pads 504d. The proximal pad 504e may be located proximal to the vibration unit (not shown) removably coupled to the mouthpiece connector 508. The distal pad 504d may be located distal to the vibration unit (not shown) removably coupled to the mouthpiece connector 508. Proximal pad 504e may have a thickness that is greater than a thickness of distal pad 504d. For example, proximal pad 504e may have a thickness in a range from about 6 mm to about 12 mm, while the thickness of distal pad 504d may be about 4 mm. Proximal pad 504e may be thicker than distal pad 504d such that proximal pad 504e may provide contact with incisor malocclusion accompanying an open bite. As such, the thickness of the plurality of pads 504a-e may be adjusted based on the condition of the user's dentition 522 such that the device 500 can provide optimal vibrational contact between the pads 504a-e and the dentition 522 of the user 520.

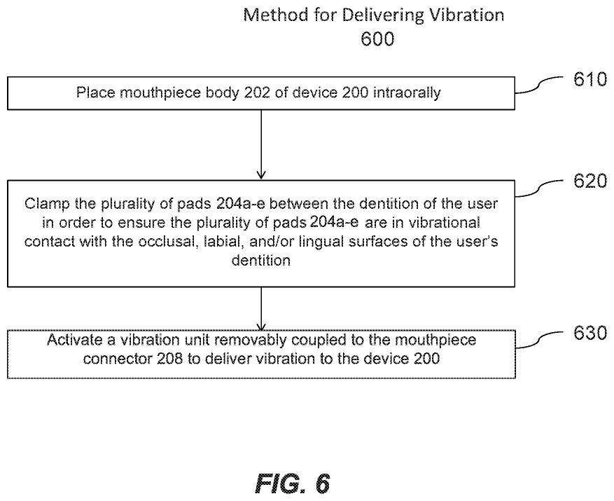

An exemplary method 600 for providing vibration to the dentition of the user may use one or more features of the embodiments of device 200, described above in reference to FIGS. 2A-2D. Exemplary embodiments of method 600 are described below with reference to FIG. 6.

As shown in FIG. 6, method 600 may include steps 610-630. Step 610 may include placing the mouthpiece body 202 of device 200 intraorally. As described above, the mouthpiece body 202 may comprise a plurality of pads 204a-e coupled to a perimeter of the mouthpiece body 202. The mouthpiece body 202 may comprise a convex curvature that approximately corresponds to a curvature of the user's palate. The mouthpiece body 202 may further comprise at least one open portion 206, for example two open portions 206. The plurality of pads 204a-e may be configured to be placed in vibrational contact with the dentition of the user.

Step 620 may include clamping the plurality of pads 204a-e between the dentition of the user. For example, the user can place the plurality of pads 204a-e between the user's teeth and clamp the plurality of pads 204a-e in order to ensure the plurality of pads 204a-e are in vibrational contact with the occlusal, labial, or lingual surfaces of the user's teeth.

Step 630 may include activating a vibration unit (not shown) removably coupled to the mouthpiece body 202 to deliver vibration. As described above, while in operation, device 200 can be configured to vibrate at a frequency higher than 30 Hz, for example between about 30 Hz and 200 Hz. In other embodiments, device 200 can be configured to vibrate at a frequency higher than about 80 Hz. For example, device 200 may vibrate at a frequency between about 100 Hz and about 120 Hz. In other aspects, the vibration unit can deliver vibration at a g-force between about 0.01 G and about 0.5 G. In some embodiments, the vibration unit can deliver vibration, for example, at a g-force between about 0.03 G and about 0.2 G. The g-force of the vibration can be adjusted.

As described herein, additional steps may be added to method 600. For example, method 600 may include adjusting the frequency and/or g-force of device 200. Method 600 may also include improving a seating of the at least one aligner by adjusting an amount of vibrational contact between the pads 204a-e and the dentition of the user. For example, the method 600 may further include adjusting an amount of upward force placed on the mouthpiece body 202. Also, some steps may be omitted or repeated, and/or may be performed simultaneously.

The foregoing description has been presented for purposes of illustration. It is not exhaustive and is not limited to precise forms or embodiments disclosed. Modifications and adaptations of the embodiments will be apparent from consideration of the specification and practice of the disclosed embodiments. For example, the described implementations include hardware and software, but systems and methods consistent with the present disclosure can be implemented as hardware alone. In addition, while certain components have been described as being coupled to one another, such components may be integrated with one another or distributed in any suitable fashion

Moreover, while illustrative embodiments have been described herein, the scope includes any and all embodiments having equivalent elements, modifications, omissions, combinations (e.g., of aspects across various embodiments), adaptations and/or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps and/or inserting or deleting steps.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

Other embodiments will be apparent from consideration of the specification and practice of the embodiments disclosed herein. It is intended that the specification and examples be considered as example only, with a true scope and spirit of the disclosed embodiments being indicated by the following claims.

Each of the following is incorporated by reference in its entirety.
Woodhouse N., Supplemental vibrational force does not reduce pain experience during initial alignment with fixed orthodontic appliances: a multicenter randomized clinical trial. Scientific Reports 2015 November; 5:17224.
Ottoson D., Vibratory stimulation for the relief of pain of dental origin. Pain 1981 February; 10(1):37-45.
Lala A., Vibration therapy in orthodontics: Realizing the benefits. Ortho 2016; 1:24-27.
Long H., Current advances in orthodontic pain. International Journal of Oral Science 2016, 8:67-75.
Krishnan V., Orthodontic pain: from causes to management—a review. European Journal of Orthodontics 29; 170-179. 2007.
Krukemeyer A., Pain and Orthodontic Treatment. Angle Orthodontist 2009, Vol. 79, No. 6.
Keim R., Managing Orthodontic Pain. 2004, JCO Volume 38:12; 641-642. Woodhouse et al., Supplemental Vibrational force during orthodontic alignment: a randomized trial. J Dent Res. 2015; 94(5):682-9.
Marie et al., Vibratory stimulation as a method of reducing pain after orthodontic appliance adjustment. J Clin Orthod. 2003; 37(4):205-8; quiz 3-4.
ZHANG, C. et al. (2012) “Effects of mechanical vibration on proliferation and osteogenic differentiation of human periodontal ligament stem cells.” Arch Oral Biol 57(10):1395-1407.

What is claimed is:

1. A device for delivering vibration to a dentition of a user, the device comprising:
a mouthpiece body configured to be placed intraorally; and
a plurality of pads coupled to a perimeter of the mouthpiece body,
wherein the mouthpiece body comprises a convex curvature that approximately corresponds to a curvature of the user's palate,
wherein the mouthpiece body further comprises at least one open portion, and
wherein the plurality of pads are configured to be placed in vibrational contact with the dentition of the user.

2. The device of claim 1, wherein the device is waterproof.

3. The device of claim 1, wherein the mouthpiece body comprises a smooth and rigid material.

4. The device of claim 3, wherein the material comprises porcelain, plastic, polypropylene, polyurethane, or polycarbonate.

5. The device of claim 1, wherein the plurality of pads comprise resilient material.

6. The device of claim 5, wherein the resilient material comprises silicone.

7. The device of claim 1, wherein the plurality of pads are configured to contact occlusal, labial, or lingual surfaces of the dentition of the user.

8. The device of claim 1, wherein the at least one open portion is configured to permit passage of any liquid that accumulates around the mouthpiece body during use.

9. The device of claim 1, wherein a ratio of a thickness of the pads to a thickness of the mouthpiece body is between about 2:1 and about 6:1.

10. The device of claim 1, wherein pads and the mouthpiece body are configured to be removably coupled to a vibration unit for delivering vibration to the dentition of the user.

11. The device of claim 10, wherein the vibration unit comprises a power source and a motor for adjusting a frequency or g-force of vibration.

12. The device of claim 10, wherein the vibration unit is configured to deliver vibration at a frequency between about 30 Hz and about 200 Hz.

13. The device of claim 10, wherein the vibration unit is configured to deliver vibration at a frequency between about 80 Hz and about 120 Hz.

14. The device of claim 10, wherein the vibration unit is configured to deliver vibration at a g-force between about 0.01 G and about 0.5 G.

15. The device of claim 1, wherein the plurality of pads are removably coupled to the mouthpiece body.

16. The device of claim 1, wherein the plurality of pads comprise:
a first set of proximal pads; and
a second set of distal pads, wherein
a thickness of the first set of proximal pads is greater than a thickness of the second set of distal pads such that the first set of proximal pads provide contact with incisor malocclusion accompanying an open bite.

17. The device of claim 16, wherein the thickness of the first set of proximal pads is in a range from about 6 mm to about 12 mm.

18. A method of delivering vibration to a dentition of a user, the method comprising:
placing a mouthpiece body intraorally, the mouthpiece body comprising a plurality of pads coupled to a perimeter of the mouthpiece body;
clamping the plurality of pads between the dentition of the user; and
activating a vibration unit removably coupled to the mouthpiece body so as to deliver vibration to the dentition of the user,
wherein the mouthpiece body comprises a convex curvature that approximately corresponds to a curvature of the user's palate,
wherein the mouthpiece body further comprises at least one open portion, and
wherein the plurality of pads are configured to be placed in vibrational contact with the dentition of the user.

19. The method of claim 18, wherein the plurality of pads are in vibrational contact with occlusal, labial, or lingual surfaces of the dentition of the user.

20. The method of claim 18, wherein the plurality of pads comprise:
a first set of proximal pads; and
a second set of distal pads, wherein
a thickness of the first set of proximal pads is greater than a thickness of the second set of distal pads such that the first set of proximal pads provide contact with incisor malocclusion accompanying an open bite.

21. The method of claim 18, further comprising delivering vibration at a frequency between about 30 Hz and about 200 Hz and at a g-force between about 0.01 G and about 0.5 G.

22. The method of claim 18, further comprising delivering vibration at a frequency between about 80 Hz and about 120 Hz.
